(19) United States
(12) Patent Application Publication
(10) Pub. No.: US 2002/0131121 A1
(43) Pub. Date: Sep. 19, 2002

(54) Transceiver, system, and method for free-space optical communication and tracking

(76) Inventors: Muthu Jeganathan, Thousand Oaks, CA (US); Kamran Kiasaleh, Oak Park, CA (US)

Correspondence Address: Optical Crossing, Inc., Suite 70, 411 N. Central Ave., Glendale, CA, 91203, US

(21) Appl. No.: 09/808,496

(22) Filed: Mar. 13, 2001

(51) Int. Cl. H04B 10/00

(52) U.S. Cl. 359/152; 359/172

(57) ABSTRACT

A transceiver, method, and system for optical communication. The system including at least a first and second optical transceivers each having an optical assembly unit with a single-aperture for transmitting and receiving optical communication signals and receiving beacon signals, and the optical assembly unit having one or more light sources attached thereto for emitting beacon signals. The transceiver, method, and system providing for superior tracking of optical communication signals/light beams transmitting information in free-space.

### FIELD OF THE INVENTION

This invention relates generally to the field of optical communication systems. More particularly, the invention relates to a free-space optical communication system including one or more optical transceivers for transmitting and receiving optical communication and beacon signals.

### BACKGROUND OF THE INVENTION

In a conventional terrestrial free-space/wireless optical communication application, two transceivers having a line of sight (LOS) unobstructed path between them are placed on roof-tops or in offices behind windows. Modulated light transmitted from one transceiver propagates through the atmosphere to the other transceiver where a portion of the light is collected and detected. An example of a system for wireless optical communication application is provided in U.S. Pat. No. 5,777,768, issued to Korevaar, is herein incorporated by reference.

Often the optical communication beams are made wider than the angular uncertainties/deviations or jitter of the beams so that the receiver always sees the transmitted beam, which of course reduces the power delivered to the receiver. It is, therefore, desirable in some cases to keep the communication beam narrow, in which case adequate alignment must be maintained between the transceivers at all times to ensure a reasonably high signal-to-noise ratio at the detector. An active auto-alignment/auto-tracking system with sensors and active pointing mechanisms can be used to keep the transceivers aligned. The sensors detect the apparent change in position of the other transceiver (caused by numerous factors such as the wind, temperature loading, building motion, and atmosphere induced tilt). A controller then adjusts the active pointing mechanism accordingly to move the entire transceiver apparatus and direct the transmitted light to the receiver.

The invention described here provides a novel transceiver and system for performing robust, but inexpensive, tracking to maintain superior alignment between the transceivers. The system is highly immune to background light so that alignment can be maintained even with the sun behind one of the transceivers. In the preferred embodiment, a circuitry is provided to distinguish the beacon signal from the other transceiver and the beacon signal backscattered into the same transceiver.

### BRIEF DESCRIPTION OF THE DRAWINGS

A presently preferred embodiment of the invention is described below in conjunction with the appended drawing figures, wherein like reference numerals refer to like elements in the various views, and in which,

FIG. 1 is a schematic representation of the optical communication system according to the present invention;

FIG. 2 is a front view representation of an arrangement of the light sources according to a first embodiment of the present invention;

FIG. 3 is a front view representation of an arrangement of the light sources according to a second embodiment of the present invention;

FIG. 4 is a front view representation of an arrangement of the light sources according to a third embodiment of the present invention;

FIG. 5 is a front view representation of an arrangement of the light sources according to a fourth embodiment of the present invention;

FIG. 6 is a detailed schematic representation of the transceiver in accordance with the present invention;

FIG. 7 is a detailed representation of the circuitry of the signal processing electronics of the transceiver in FIG. 6 in accordance to the present invention;

FIG. 8 is a representation of a light beam emitted from a light source and backscattered into the transceiver;

FIG. 9 is a representation of the intensity profile of the narrow optical communication signal/beam in accordance with the present invention.

### DETAILED DESCRIPTION OF THE PREFERRED EMBODIMENTS

The present invention provides a free-space optical communication system including one or more optical transceivers each having an optical assembly unit with a single-aperture and one or more light sources attached to the optical assembly unit. The optical assembly units transmit and receive optical communication signals such as data, voice, and video information through the single-aperture. The light sources emit beacon signals which are received and detected by the optical assembly units and may also provide low-data-rate optical signals for diagnostic, status, handshaking or other purposes. The system is particularly suited for optical communications in situations where precision tracking is required for a superior performance.

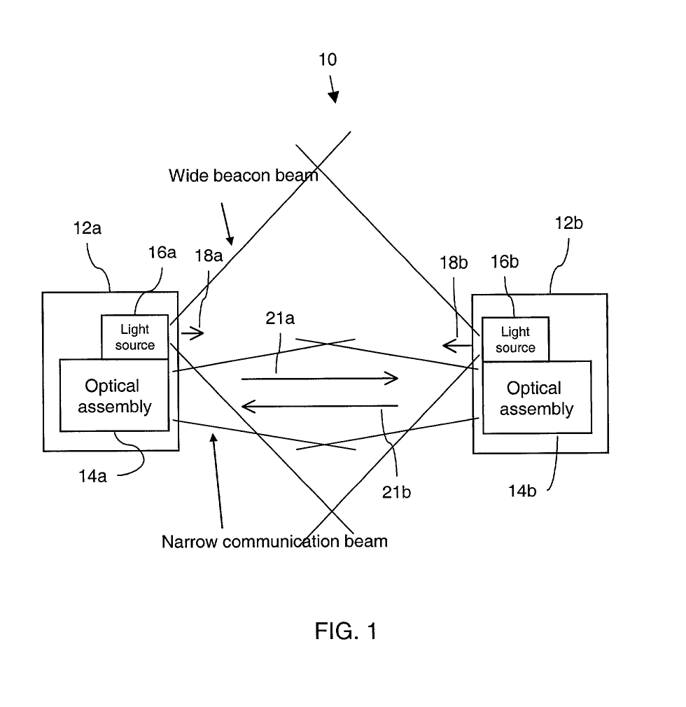

Referring to FIG. 1, a free-space optical communication system 10 according to a presently preferred embodiment is shown schematically. The system 10 includes at least a pair of optical transceivers, namely a first transceiver 12a and a second transceiver 12b. Each transceiver 12a and 12b include an optical assembly 14a and 14b respectively. One or more light sources 16a and 16b are attached to each optical assembly 14a and 14b, respectively. The light sources 16a and 16b emit beacon signals 18 and 18b in the form of optical signals/beams of light. The light sources 16a and 16b have a wide enough beam divergence/width such that the receiver sees the beacon despite any nominal transceiver motion or jitter. The light sources 16a and 16b are preferably light emitting diodes (LEDs). LEDs are particularly suited because they are cost-effective, are readily available, have large beam-width (larger than 1 degree) and can be used without additional optics or further processing. The light sources 16a and 16b may also be super luminescent diodes (SLDs), lasers and fiber-coupled lasers with or without collimators, side-emitting or leaky fibers or other optical devices capable of emitting optical signals for use primarily as beacon signals and low-speed data. According to the present invention, the light sources emit optical signals having wavelengths in the range of about 750 nm-950 nm although other wavelengths are possible. The wavelength choice is primarily determined by the availability of low-cost, high-power LEDs and low-cost multi-element/array photodetectors at these wavelengths. Another key aspect of the invention is the intensity modulation of the beacon light source which enables the receiver to distinguish the beacon signal from either direct or scattered sun-light, moonlight, street lights or other nearby lights. A lock-in detection circuitry (described below), part of the post-processing electronics, enables the received signal to be demodulated to determine received signal strength. After demodulation, the received signal can be processed to determine where the transmit communication beam should be pointed and the beam directing mechanism can be adjusted accordingly.

In the communication system 10 according to the present invention, the optical assemblies 14a and 14b of transceivers 12a and 12b each have a single-aperture construction. According to the preferred embodiment of the present invention, optical communication signals 21a and 21b are transmitted and received through the single-apertures of the respective transceivers 12a and 12b. The optical communication signals 21a and 21b have a narrow beamwidth/divergence to deliver maximum power to the receiver when reasonably aligned. Because of the substantial difference in the bandwidth of the beacon signals (few kHz) and communication signals (MHz to GHz or higher), the beacon detector can be made much more sensitive thereby making it possible for the beamwidth of the beacon signal to be large. The beacon signals are also received and processed through the single-apertures. This common path for the received beacon signals and communication signals is important as it allows superior tracking performance.

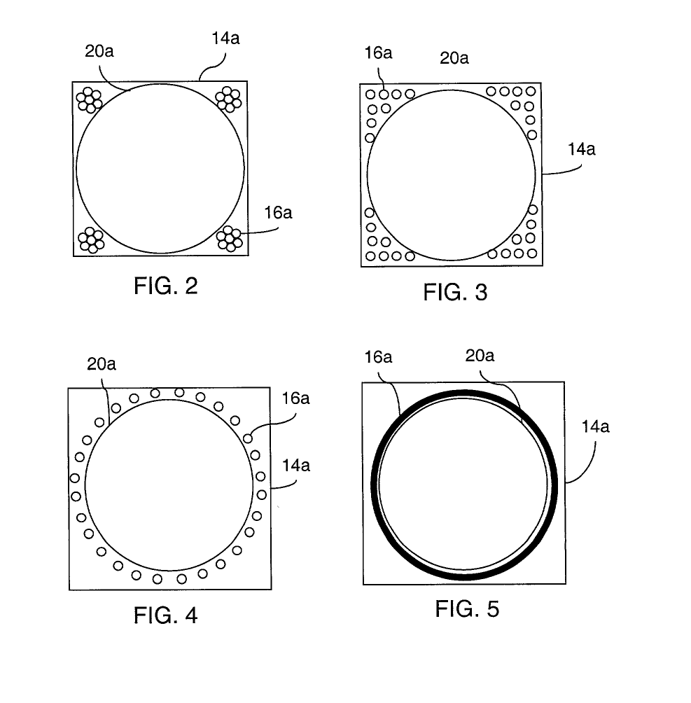

In the present invention, it is contemplated that in order to maximize the effectiveness of the reception and detection of the beacon signals, the light sources are arranged in a form of a cluster around the periphery of each optical assembly. The array/cluster of LEDS is used to increase transmit power and thus have higher signal-to-noise ratio at the beacon receiver. Referring to FIG. 2, a preferred embodiment of the arrangement of the light sources, in a form of a cluster of LEDs, according to the present invention is illustrated. As shown in FIG. 2, the light sources are positioned in cluster form at each comer of the optical assembly. FIGS. 3, 4, and 5 further illustrate second, third, and fourth embodiments of arrangements of the light sources in relation to the aperture of the optical assembly of each transceiver providing for the transmission of beacon signals. Referring to FIG. 5, a side-emitting fiber is shown for emitting the beacon signals. It is preferred that the light sources are provided at least substantially concentrically about an optical axis of the aperture to minimize offset errors.

It should be further noted that, the optical signals emitted from the light sources 16a attached to the first optical assembly 14a have different optical characteristic than the optical signals emitted from the light sources 16b of the second optical assembly 14b. This allows for the differentiation between the beacon signals of the light sources on the transceivers. These optical characteristics include, but are not limited to, wavelength, polarization and frequency of intensity modulation of the beacon signals. Furthermore, the intensity modulation itself could be frequency modulated, amplitude modulated or phase modulated in digital or analog form for further differentiation and low rate data transfer. Preferably, the frequency of intensity modulation is in the order of a kHz (100 Hz to 100 kHz) to eliminate line noise (at about 60 Hz and its harmonics) and to still provide high gain for best sensitivity. In the present invention, for example, the light sources 16a of transceiver 12a emit beacon signals/optical signals that are intensity modulated at 8 kHz, and the light sources 16b of transceiver 12b emit beacon signals/optical signals that are intensity modulated at 5 kHz. By properly designing the optics and electronics in each transceiver (for example, optical filters that match the wavelength of the beacon signals), the differentiation of beacon signals received from the other transceiver and the beacon signals backscattered from the same transceiver is achieved. The backscattered signal, if any, can be detected and processed separately to determine atmospheric attenuation or presence of other obstacles which can then be used to control transmit power of both the beacon signals and the communication signals.

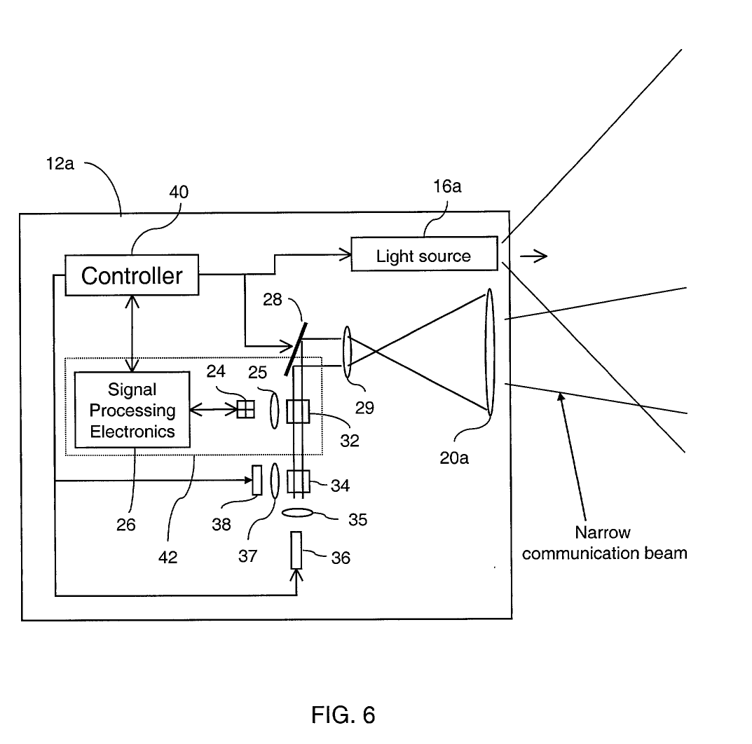

FIG. 6 is a schematic representation of the transceiver in accordance with the present invention. As shown in FIG. 6, light beams are transmitted and received through the aperture 20a. In the preferred embodiment, lens 29 images the aperture 20a on to the steering mechanism 28 and also collimates the incoming light. The incoming light beams is subsequently directed and focused using the steering mirror 28. The light beams are processed by a beam splitter 32 wherein a portion of the light beam relating to the beacon signals are directed through lens 25 towards the photodetector 24. Beam splitter 32 allows for the differentiation of beacon signal and communication signal and may be a dichroic beam splitter for wavelength separation or polarizing beam splitter for polarization separation. The detected beacon signals are processed through the signal processing electronics 26 for sensing the apparent position of the other transceiver 12b. The output of the signal processing electronics 26 is provided to the controller 40. The controller 40 controls the steering mirror for compensating for the misalignments of the transceivers in the system and providing proper tracking. Controller 40 ensures the image of the other transceiver is always maintained at a fixed position on photodetector 24 by moving the steering mechanism. Because the beacon signal and communication signal share the same optical path, the beacon tracking ensures the communication signal falls on the communication receiver 38. Similarly, the light from transmitter 36 is directed to the other transceiver by the steering mechanism. Beam splitter 34 allows for differentiation of the received communication signal and transmitted communication signal.

Referring to FIG. 6, and by way of example, transceiver 12a further includes a multi-element photo-detector 24 to detect the beacon signal and deduce the apparent position of the other transceiver. Any of a variety of detectors can be used for this purpose including, but not limited to, bi-cell, quadrant photodetector (QPD), positions sensing detector (PSD), linear array or two-dimensional array of photodetectors. Each detector element may be a p-i-n photodiode or an avalanche photodiode (APD). In the preferred embodiment, a quadrant p-i-n detector is used to sense the apparent position of the other transceiver in both dimensions. The photo-signal generated by each photodetector element is amplified and processed by additional signal processing electronics 26.

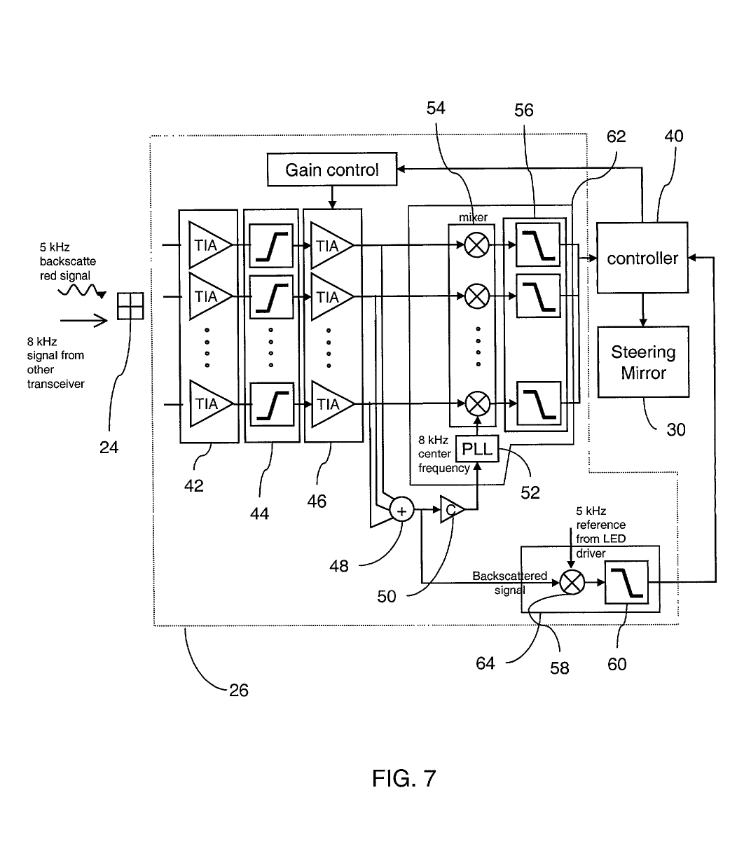

FIG. 7 is a detailed representation of the circuitry of the signal processing electronics in accordance to the present invention. Electronic high-pass filter 44 and low-pass filters 56 are used to filter the noise and pass the desired signals. In the preferred embodiment, the amplified (using amplifiers 42 and 46) and filtered signals from all elements of the photodetector are summed by the summer 48. A well-designed optical system will ensure that the summed or total signal will be fairly constant on a short time scale. The summed signal can then be used to generate a reference signal with a limiting amplifier or comparator 50 and phase-locked-loop (PLL) 52 circuitry. The individual photodetector signals when mixed (for example, multiplied) by the mixer 54 with the reference signal and filtered by the low-pass filter 56, provide a measure of the signal amplitude on each element of the photodetector. This process of demodulation by multiplying the signal with a reference is called “lock-in detection” and is beneficial in detecting very small signals. It should be noted that the lock-in detection is achieved by the non-local reference, i.e., the reference is generated from the received beacon signal and the PLL. Note that part of the signal processing electronics is matched to the signal from the other transceiver. That is, signal receiver 62 of transceiver 12b is matched to light source 16a of transceiver 12a and signal receiver 62 of transceiver 12a is matched to light source 16b of transceiver 12b. A controller can then estimate the apparent position of the other transceiver from the relative strength of signals on each photodetector element, and adjust the beam directing mechanism to transmit the communication signal towards the other transceiver.

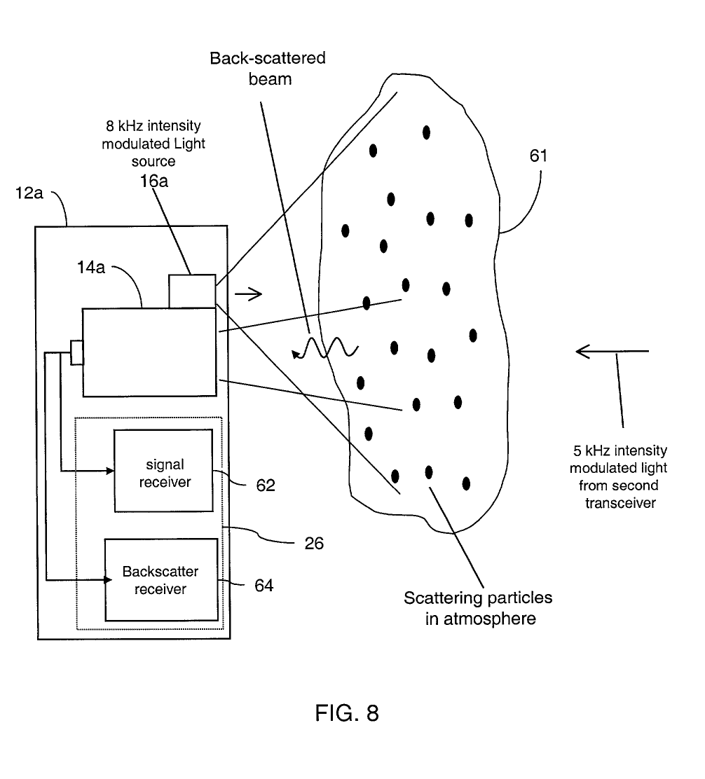

FIG. 8 is a representation of a light beam emitted from a light source and backscattered into the transceiver. By way of example, referring to FIG. 8, the aperture of transceiver 12a receives beacon signals not only at 5 kHz from the other transceiver but also at 8 kHz if light from light source 16a of transceiver 12a is backscattered into the aperture of transceiver 12a, because of particles in the atmosphere 61 or other obstacles. The signal processing electronics 42 of transceiver 12a has both a signal receiver circuitry 62 matched to 5 kHz and a backscatter receiver circuitry 64 matched to 8 kHz. The backscatter receiver 64 comprises of another lock-in detection circuitry with a mixer 58 and low pass filter 60. The reference for mixer 58 is obtained from the intensity modulation circuitry of light source 16a. The demodulated signal from the backscattered receiver 64 is then provided to the controller (not shown in FIG. 8) wherein the output powers of the transmitter 36 and light source 16a of transceiver 12a are controlled, hence, compensating for adverse atmospheric conditions.

As explained above and referring to FIG. 6, transceiver 12a, includes a mechanism 28 for directing and focusing the received optical signals. Preferably, this mechanism is a two-axis steering mirror providing superior alignment of the two transceivers 12a and 12b, in the system 10 such that the incident light is properly focused and directed onto the beacon photodetector 24 and communication receiver 38 for detection of the received optical signals. In the present invention, the wavelengths of the communications signals generated via a transmitting laser are different than the beacon signal wavelengths. For example, telecommunication industry standard wavelengths around 1300 nm or 1550 nm are preferred choices for the communication signals. The substantially different wavelengths of the beacon signal and communication signal allows for conveniently and effectively separating the two signals with optical filters. The aforementioned communication signal light beams have a narrow beam; therefore, it is important to provide a steering mirror for the proper operation of the transceivers. The steering mirror advantageously enables the tracking of the transmitted and received optical signals in the optical communication system 10. The utilization of narrow light beams for the communication signals advantageously provides for high data rate (e.g. larger than 1 gigabits per second) information transfer capability for the optical communication system of the present invention. The mechanism 28 may also be a single-axis mirror, a hologram or any component of similar functionality or of a type well known in the pertinent art. It should be noted that the mechanism 28 provided inside the optical assembly 14a combined with the common optical path for transmitting and receiving communication signals and receiving beacon signals eliminate the requirement for a controllable gimbal apparatus or an actuator to mechanically move and align the entire transceiver apparatus. Because only a small mirror is steered as opposed to the whole transceiver or optical assembly, the bandwidth of the tracking can be significantly higher (greater than 100 Hz). Typically, building sway, wind and temperature effects are rather slow (less than several Hz). The tilt induced by the atmosphere (angle of arrival fluctuations), however, can be much faster (tens of Hz). The higher bandwidth, thus, allows correction of atmospheric induced tilt.

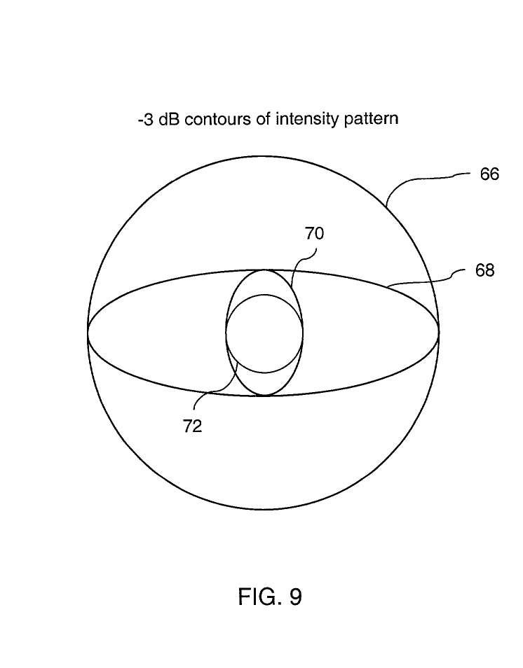

FIG. 9 is a representation of the intensity profile of the narrow received optical communication signal/beam in accordance with the present invention. Intensity profile 66 represents the beam shape at the receiver in a conventional system to cover beam jitter, motion or deviation. In a conventional system, since the receiver aperture is much smaller than the beam, much of the energy is wasted. Under certain instances, the apparent motion of a transceiver is predominantly in the horizontal direction. This is because buildings sway side to side, not up and down. Also horizontal components of winds tend to be stronger. In these cases, it is desirable to have an elliptical beam divergence (wider horizontally than vertically) such that energy is concentrated in a smaller beam profile 68. In the present invention, auto-alignment feature is employed in the horizontal axis with a single-axis steering mechanism, wherein even smaller elliptical beam 70 is achieved for the communication signal such that the major axis (larger divergence) is along the vertical (uncompensated) axis and the minor axis is along the horizontal (compensated) axis. The degree of ellipticity is determined by the performance of the tracking (compensation) system and the jitter in the vertical axis. If the auto-tracking feature is employed in both axes (i.e. compensation in both horizontal and vertical axes), a very narrow beam profile 72 may be used to deliver optimum signal to the receiver.

As noted earlier, the beacon signals are intensity modulated at a particular frequency for lock-in detection by the other transceiver. In the preferred embodiment, the intensity modulation of the beacon can itself be modulated, therefore, enabling the transmission/reception of low-data-rate information in addition to providing the tracking capability for the optical communication system 10. For example, the intensity modulation of the beacon signals may be amplitude modulated (AM), frequency modulated (FM) or phase modulated (PM) in digital or analog form for providing of the low-data-rate information with the beacon signals. In the present invention, it is contemplated that the intensity of the beacon signal is frequency modulated in a digital form where the frequency of the modulating signal is changed from one frequency (representing a bit “0”) to another frequency (representing a bit “1”). The phase-locked-loop is then used to detect the different frequencies and determine the bit value without impacting the tracking system. By way of example, the frequency of intensity modulation of light source 16a can be switched between 8 kHz and 8.1 kHz to transmit data and the phase-locked-loop 52 in transceiver 12b can be used to decode the data. The low-data-rate capability on the beacon signals provides for reduction in the over-head information transmission on the optical communication signals and, as mentioned above, further provides for diagnostic, handshaking and other useful information in controlling the operation of the optical communication system 10 of the present invention. Thus, with a minimal amount of additional circuitry, information can be exchanged between the transceivers to further optimize the data link established through the communication signals. This is especially useful in a high-data-rate system where it is difficult to inject status/diagnostic information in the communication signal data stream.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalence of the claims, are to be embraced within their scope.

We claim:

1. An optical transceiver for free-space communication, comprising:
an optical assembly unit for transmitting and receiving optical communication signals and for receiving beacon signals;
one or more light sources attached to the optical assembly unit for transmitting beacon signals.

2. The optical transceiver of claim 1, wherein the one or more light sources are light-emitting diodes (LED's).

3. The optical transceiver of claim 1, wherein the one or more light sources are lasers.

4. The optical transceiver of claim 1, wherein the one or more light sources are super luminescent diodes (SLDs).

5. The optical transceiver of claim 1, wherein the one or more light sources are side-emitting fibers.

6. The optical transceiver of claim 2, wherein the light-emitting diodes are provided in a circular array at least substantially concentrically about an optical axis of an aperture of the optical assembly.

7. The optical transceiver of claim 2, wherein the light-emitting diodes are provided in a cluster at least substantially concentrically about an optical axis of an aperture of the optical assembly.

8. The optical transceiver of claim 1, wherein the one or more light sources emit modulated beacon signals.

9. The optical transceiver of claim 8, wherein the one or more light sources are intensity-modulated (IM).

10. The optical transceiver of claim 9, wherein the light source intensity is amplitude-modulated (AM) in digital or analog form, thereby allowing for lock-in detection of the beacon signals by a remote transceiver.

11. The optical transceiver of claim 9, wherein the intensity of the one or more light sources is modulated for information transmission.

12. The optical transceiver of claim 1, wherein the beacon signals are modulated for transmitting data thereon.

13. The optical transceiver of claim 10, wherein the frequency of AM is selected based on atmospheric-induced noise, such that noise effects are minimized.

14. The optical transceiver of claim 10, wherein the frequency of amplitude modulation of the one or more light sources is in a range of about 100 Hz to 100 kHz in frequency.

15. The optical transceiver of claim 10, wherein the intensity of the one or more light sources are frequency-modulated (FM) in digital or analog form.

16. The optical transceiver of claim 10, wherein the intensity of the one or more light sources are phase-modulated (PM) in digital or analog form.

17. The optical transceiver of claim 1, wherein the optical assembly unit further comprises a mechanism for directing and focusing the optical communication signals and the beacon signals.

18. The optical transceiver of claim 17, wherein the mechanism is a steering mirror.

19. The optical transceiver of claim 18, wherein the steering mirror is a two-axis mirror.

20. The optical transceiver of claim 18, wherein the steering mirror is a single-axis mirror.

21. The optical transceiver of claim 17, wherein the mechanism is a hologram.

22. The optical transceiver of claim 1, further comprising a controller for adjusting power for the one or more light sources.

23. The optical transceiver of claim 1, further comprising a beacon receiving unit, wherein the receiving unit includes one or more photo-detectors for sensing received beacon signals from a remote transceiver or backscattered beacon signals and generating detected signals.

24. The optical transceiver of claim 23, wherein the detected signals are provided to a controller for controlling the optical communication signals and the beacon signals.

25. The optical transceiver of claim 23, wherein the one or more photodetectors are photodiodes.

26. The optical transceiver of claim 23, further comprising a circuitry for lock-in detection of received beacon signals.

27. The optical transceiver of claim 26, wherein the lock-in detection is accomplished with a PLL to generate a reference signal from the received beacon signals.

28. The optical transceiver of claim 1, wherein the optical assembly unit includes a single-aperture.

29. A free-space optical communication system including at least a pair of optical transceivers for transmitting and receiving optical signals there between, comprising:
a first optical transceiver having an optical assembly unit with a single-aperture for transmitting and receiving optical communication signals and receiving beacon signals, the optical assembly unit having one or more light sources attached thereto for emitting beacon signals; and
a second optical transceiver having an optical assembly unit with a single-aperture optically coupled to the first optical transceiver for transmitting and receiving optical communication signals and receiving beacon signals, the second optical transceiver having one or more light sources attached thereto for emitting beacon signals.

30. The free-space optical communication system of claim 29, wherein the transmitted communication signals from the first optical transceiver have a first optical characteristics and the transmitted communication signals from the second optical transceiver have a second optical characteristic.

31. The free-space optical communication system of claim 29, wherein the first optical characteristic of the communication signals emitted from the first optical transceiver comprises a first predetermined wavelength and the second optical characteristic of the communication signals emitted from the second optical transceiver comprises a second predetermined wavelength.

32. The free-space optical communication system of claim 29, wherein the first optical characteristic of the communication signals emitted from the first optical transceiver comprises a first predetermined modulation frequency and the second optical characteristic of the communication signals emitted from the second optical transceiver comprises a second predetermined modulation frequency.

33. The free-space optical communication system of claim 29, wherein the first optical characteristic of the communication signals emitted from the first optical transceiver comprises a first predetermined polarization and the second optical characteristic of the communication signals emitted from the second optical transceiver comprises a second predetermined polarization.

34. The free-space optical communication system of claim 31, wherein the first predetermined wavelength and the second predetermined wavelength are in the range of about 1300 nanometer to about 1550 nanometer.

35. The free-space optical communication system of claim 29, wherein the beacon signals emitted from the first optical transceiver have a first optical characteristic and the beacon signals emitted from the second optical transceiver have a second optical characteristic.

36. The free-space optical communication system of claim 29, wherein the first optical transceiver receiving the beacon signals from the second optical transceiver is adapted to track the optical communication signals from the second optical transceiver, wherein the second optical transceiver receiving the beacon signals from the first optical transceiver is adapted to track the optical communication signals from the first optical transceiver.

37. The free-space optical communication system of claim 35, wherein the first optical characteristic of the beacon signals emitted from the first optical transceiver comprises a first predetermined wavelength and the second optical characteristic of the beacon signals emitted from the second optical transceiver comprises a second predetermined wavelength.

38. The free-space optical communication system of claim 3 5, wherein the first optical characteristic of the beacon signals emitted from the first optical transceiver comprises a first predetermined modulation frequency and the second optical characteristic of the beacon signals emitted from the second optical transceiver comprises a second predetermined modulation frequency.

39. The free-space optical communication system of claim 35, wherein the first optical characteristic of the beacon signals emitted from the first optical transceiver comprises a first predetermined polarization and the second optical characteristic of the beacon signals emitted from the second optical transceiver comprises a second predetermined polarization.

40. The free-space optical communication system of claim 35, wherein the first optical transceiver receives the beacon signals having the second predetermined modulation frequency from the second optical transceiver, wherein the second optical transceiver receives the beacon signals having the first predetermined modulation frequency from the first optical transceiver.

41. A method for providing free-space optical communication, comprising the steps of:
providing an optical transceiver having an optical assembly unit;
providing one or more light sources attached to the optical assembly unit;
transmitting and receiving optical communication signals through the optical assembly unit; and
receiving beacon signals through the optical assembly unit.

42. The method of claim 41, wherein the optical assembly unit comprises a single-aperture.

43. The method of claim 41, wherein the one or more light sources emitting beacon signals.

44. The method of claim 43, further comprising:
modulating the beacon signals emitted from the one or more light sources.

45. The method of claim 44, further comprising:
intensity modulating the beacon signals emitted from the one or more light sources.

46. The method of claim 45, further comprising:
amplitude modulating the intensity modulated beacon signals emitted from the one or more light sources.

47. A method for communication in a free-space optical communication system, comprising the steps of:
providing a first optical transceiver having an optical assembly unit with a single-aperture and one or more light sources attached thereto;
providing a second optical transceiver having an optical assembly unit with a single-aperture and one or more light sources attached thereto;
optically coupling the first optical transceiver and the second optical transceiver;
transmitting and receiving optical communication signals.

48. The method of claim 47, further comprising the steps of:
emitting beacon signals from the one or more light sources of the first optical transceiver, wherein the beacon signals have a first optical characteristic;
emitting beacon signals from the one or more light sources of the second optical transceiver, wherein the beacon signals have a second optical characteristic.

49. The method of claim 48, wherein the first optical characteristic of the beacon signals emitted from the first optical transceiver comprises a first predetermined wavelength and the second optical characteristic of the beacon signals emitted from the second optical transceiver comprises a second predetermined wavelength.

50. The method of claim 48, wherein the first optical characteristic of the beacon signals emitted from the first optical transceiver comprises a first predetermined modulation frequency and the second optical characteristic of the beacon signals emitted from the second optical transceiver comprises a second predetermined modulation frequency.

51. The method of claim 48, wherein the first optical characteristic of the beacon signals emitted from the first optical transceiver comprises a first predetermined polarization and the second optical characteristic of the beacon signals emitted from the second optical transceiver comprises a second predetermined polarization.
